(19) United States
(12) Patent Application Publication
(10) Pub. No.: US 2025/0135519 A1
(43) Pub. Date: May 1, 2025

(54) THERMALLY BROKEN STRUCTURAL TUBE

(71) Applicant: Todd Noe, Del Mar, CA (US)

(72) Inventor: Todd Noe, Del Mar, CA (US)

(21) Appl. No.: 18/384,413

(22) Filed: Oct. 27, 2023

(51) Int. Cl. B21C 37/15

(52) U.S. Cl. CPC B21C 37/155

(57) ABSTRACT

The invention is a structural metal tube with a built-in thermal break composed of only four components, two metal extruded portions and two composite strut portions. The thermal break between the metallic portions interrupts the otherwise high thermal conductivity that would exist if the metallic portions were joined. The low-thermal-conductivity composite strut portions disrupt the thermal conductivity between the metallic portions.

### TECHNICAL FIELD

The invention is a structural metal tube with a built-in thermal break.

### BACKGROUND OF INVENTION

Metal tubing has been around for thousands of years. Metal tubes are often rolled, folded or extruded as one enclosed form providing highly structural properties.

Typically, conventional structures designed out of metal tubing require some form of added insulation in order to prevent the conduction of heat and cold throughout the structure.

### BRIEF DESCRIPTION OF THE INVENTION

The invention is a thermally broken structural metal tube comprising four components: two metal extruded portions; and composite strut portions. These tubes are to be utilized for the construction of a variety of structures. There are two embodiments of the tubing, with different construction aspects, for different requirements. One embodiment comprises symmetrical metallic and composite portions; the other comprises asymmetrical metallic portions with symmetrical composite portions.

Intermediate tubes are utilized for connections on parallel faces of the tube.

For the construction of intermediate tubes, both metallic halves of the tube are symmetrical C-shaped metal components mirroring each other with interior flange slots. The joining portion of the tube is the composite strut portions with flange slots that fit securely within the metallic portions' slots.

Corner tubes are utilized for connections on the perpendicular faces of the tube.

For the construction of corner tubes, one of the two metal components is a smaller, V-shaped extrusion, whose lengths are half the length of one side of the larger metallic component.

In both embodiments, the composite struts portions flange slots are inserted into the corresponding flange slots of both metal portions providing a snug fit and joining the two metal halves without either side having direct contact with one another due to the dimensioned spacing of the joining connecting struts. This separation of the two metallic portions establishes the thermal break thereby reducing thermal conductivity between the two metallic portions.

### BRIEF DESCRIPTION OF DRAWINGS

FIG. 1a shows the metal portions of the intermediate tube comprising a C-shaped extrusion with flange slots on either end.

FIG. 1b shows the composite strut portions of the intermediate tube.

FIG. 2a shows a top-down view of metal and composite components before assembly.

FIG. 2b shows a top-down view of the intermediate tube assembled.

FIG. 3a shows a side view of assembled metal and composite components.

FIG. 3b shows a front view of the metal and composite components.

FIG. 4 shows a perspective and top-down view of corner tube.

FIG. 5a shows one section of corner tube in top-down and side view.

FIG. 5b shows other section of corner tube in top-down and side view.

FIG. 6 shows the composite strut portions of the corner tube.

FIG. 7a shows top-down view of corner tube components before assembly.

FIG. 7b shows an assembled view of the corner tube.

### DETAILED DESCRIPTION OF INVENTION

Metal tubing has been around for thousands of years. Steel tubing had been utilized for its light weight, and structural integrity to build myriad structures.

Most conventional steel tubes are composed of one continuous profile of metal created through a method of rolling, folding or extrusion. Metals are good conductors of thermal energy. Therefore, a metal structure that is essentially a non-thermally-broken structure will allow heat flow between areas with significant temperature differential. For example, a metal outside door to a dwelling where inside temperature is to be maintained at, say, 68-degrees Fahrenheit, and where outside temperature is 38-degrees Fahrenheit, will have significant heat flow through the door from inside to outside. That will make keeping the inside temperature at 68 degrees both inefficient and costly. On the other hand, if the thermal conductivity is broken, that is, if a poor heat conducting material is used to join two metal portions, leaving a gap between the metal portions, the poor conductor will act as insulation, reducing the thermal flow and increasing the inside heating efficiency. Composite materials are known that have thermal conductivity characteristics that are an order of magnitude lower than that of good heat-conducting metals.

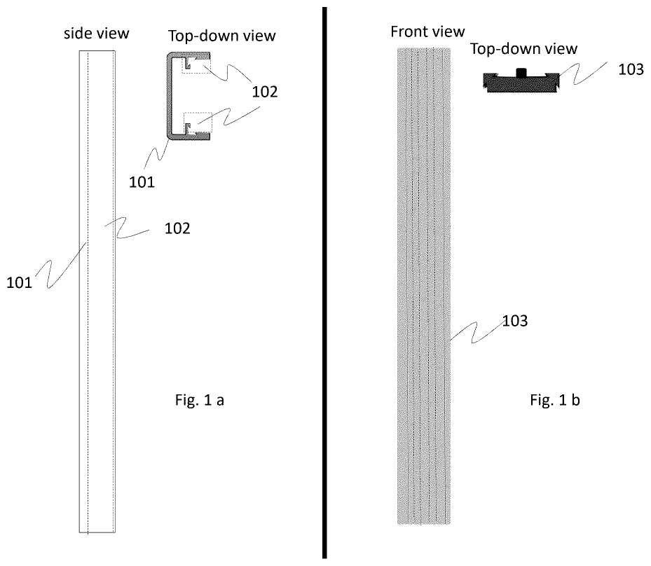

The invention consists of four separate extruded components, rather than just one. Two halves being metal components (FIG. 1a, 101) are an extruded profile with an internal slot (FIG. 1a, 102) on either end of the profile The remaining components are two composite struts (FIG. 1b, 103) with their own corresponding flange slots on either end.

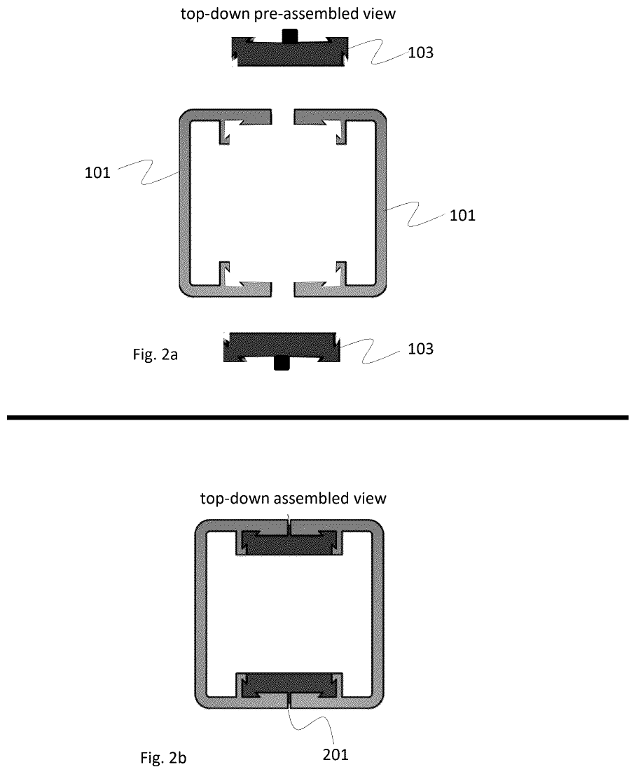

The metal and composite portions, as shown in FIG. 2a, allows assembling them by sliding the composite struts' flanges 103 into the metal components' internal slots (FIG. 1, 102).

FIG. 2b depicts the assembled tubes with the composite portions' flanges fully inserted into the metal portions' internal slots providing a snug fit with the two metal components separated only by the thickness of the struts thermal break point (FIG. 2b, 201).

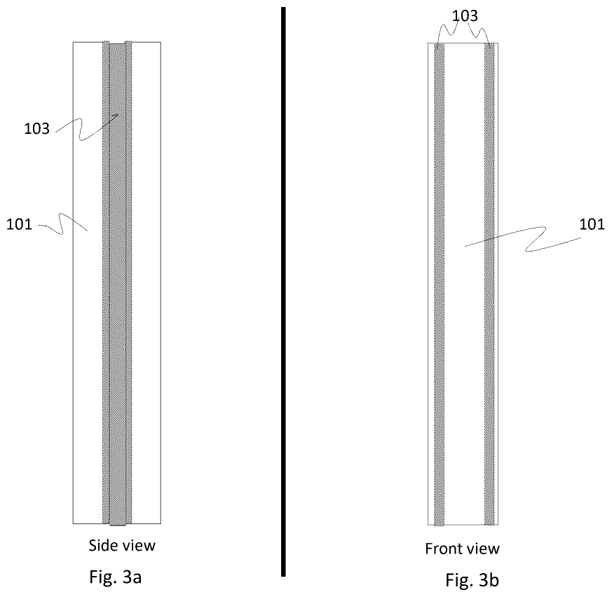

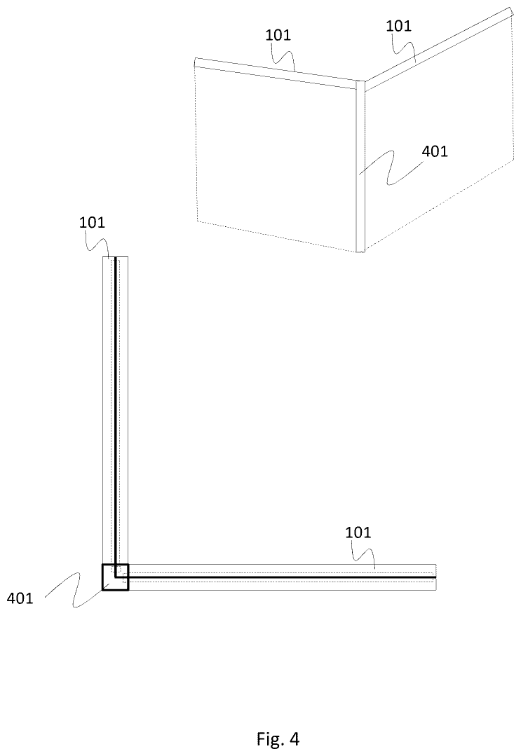

In FIG. 3a, the assembled extrusion (101) and composite (103 structures are shown in a side view revealing the thermal break (201).

In FIG. 3b, a front-view is depicted showing the juxtapositions of extrusion (101) and composites (103).

A corner tube (401) embodiment is shown in perspective and top-down view meeting two intermediate tube embodiments (101). The intermediate tubes are at right angles to one another, and the corner tube extends at right angles to the intermediate tubes, as shown.

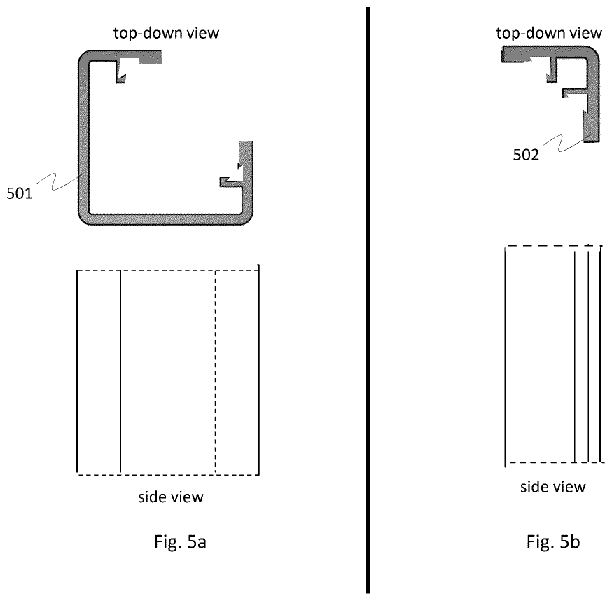

FIG. 5a shows the large portion of the asymmetrical corner tube (501) and its two, partial, internal flange slots in top-down and side views.

FIG. 5b shows the small portion of the asymmetrical corner tube (502) and its two, partial, internal flange slots in top=down and side views.

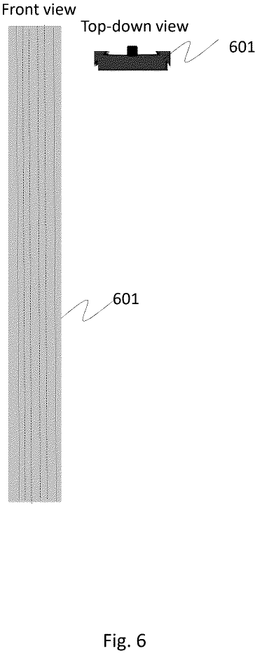

FIG. 6 shows the composite strut (601) with its corresponding flange slots.

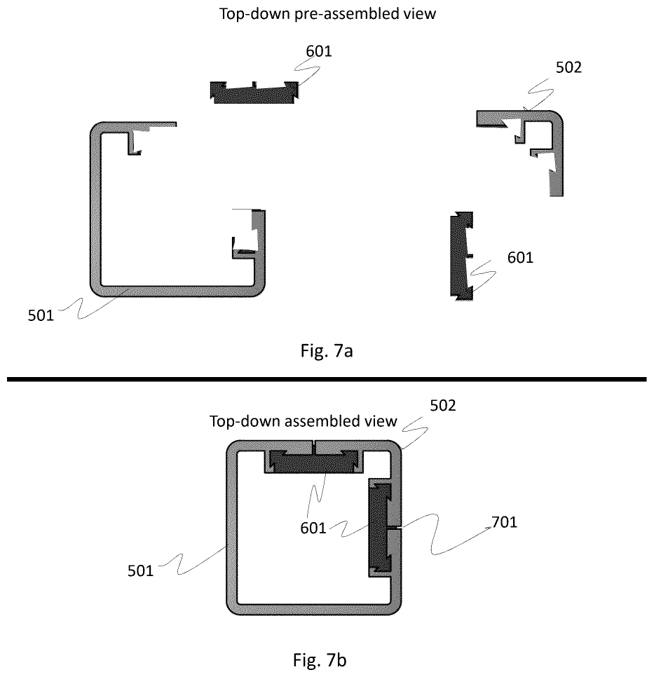

FIG. 7a shows the asymmetrical large (501) and small (502) portions and its two composite components (601) prior to assembly in top-down views.

FIG. 7b shows the corner tube after assembly in top-down views and the thermal break spot, 701.

The thermally broken tubes' metallic portions may comprise rigid metals and metal alloys.

The thermally broken tubes composite portions may comprise non-metallic materials having thermal conductivity that are at least an order of magnitude lower than the metallic portions' thermal conductivity.

What is claimed is:

1. A thermally-broken tube comprising;
two metallic portions;
two composite portions;
the metallic portions have internal slots; and
the composite portions have flanges operative to fit within the internal slots of the metallic portions establishing a firm, tight, construction with a gap between the metallic portion's edges that breaks thermal conductivity between the two metallic portions.

2. A claim as in claim 1 wherein:
the metallic portions and composite portions are extruded, single-piece structures.

3. A claim as in claim 2 wherein:
the metallic portions, with internal slots, are composed of metal material.

4. A claim as in claim 2 wherein:
the composite portions comprise non-metallic material.
